(19) United States
(12) Patent Application Publication
(10) Pub. No.: US 2017/0147714 A1
(43) Pub. Date: May 25, 2017

(54) VERIFICATION METHOD OF CLEARANCE DESIGN

(71) Applicants: Inventec (Pudong) Technology Corporation, Shanghai (CN); INVENTEC CORPORATION, Taipei City (TW)

(72) Inventors: Cheng-Hsin CHEN, TAIPEI CITY (TW); Chun-Hung LIN, TAIPEI CITY (TW)

(21) Appl. No.: 15/080,535

(22) Filed: Mar. 24, 2016

(30) Foreign Application Priority Data
Nov. 23, 2015 (CN) 201510819254.0

(51) Int. Cl. G06F 17/50

(52) U.S. Cl. CPC G06F 17/50

(57) ABSTRACT

A verification method is disclosed. A first entity pattern and a second entity pattern are provided, and a clearance exists between the first entity pattern and the second entity pattern. A third entity pattern is provided by starting from the first entity pattern and moving toward the second entity pattern according to a predetermined clearance value. By determining whether a partial overlap happens between the third entity pattern and the second entity pattern or not by interference inspection to verify whether the size of the clearance is within a safe range of a clearance design or not.

### RELATED APPLICATIONS

This application claims priority to Chinese Application Serial Number 201510819254.0, filed on Nov. 23, 2015, which is herein incorporated by reference.

### BACKGROUND

Field of Invention

The present disclosure relates to a verification method. More particularly, the present disclosure relates to verification about a clearance between two entity patterns according to a safe range of clearance design.

Description of Related Art

When a physical structure with a computer-based design layout is produced by a manufacturing process, a result of the physical structure produced by the manufacturing process will somehow different from the original design layout. In fact, there will be some distortions between the produced physical structure and the original design layout. In order to avoid some malfunctions caused by the distortions, gaps are reserved between components in the design layout to compensate the distortions. Other than the distortion issues, an environment of using the physical structure must be also considered while designing the physical structure. In order to operate the physical structure properly in various environments, gaps are reserved to overcome variables caused by different conditions of operating environments.

Aforesaid gaps reversed for the manufacturing distortions or for the operating environments are regarded as clearances in computer-based layout designs. However, while designing a layout with current computer-aided design (CAD) software, the CAD software provides a built-in function to verify only the smallest clearance between two entity patterns. The built-in function of the CAD software is not able to verify several different clearances between the two entity patterns.

### SUMMARY

The invention provides a verification method to verify the clearance design using interference inspection in computer software. The verification method includes at least following steps. A first entity pattern and a second entity pattern are provided. A clearance exists between the first entity pattern and the second entity pattern. A third entity pattern is formed according to a predetermined clearance value. The third entity pattern is started from an edge of the first entity pattern and extended toward the second entity pattern. Whether the clearance complies with a safe range of clearance design or not is verified according to interference inspection. The interference inspection is utilized to detect whether the third entity pattern partially overlaps the second entity pattern or not.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a schematic diagram of a mechanism in accordance with one embodiment of the present disclosure.

FIG. 2 is a flow chart of a method illustrating a verification method in accordance with one embodiment of the present disclosure.

FIG. 3A to FIG. 3F are schematic diagrams illustrating entity patterns in clearance verification according to embodiments of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

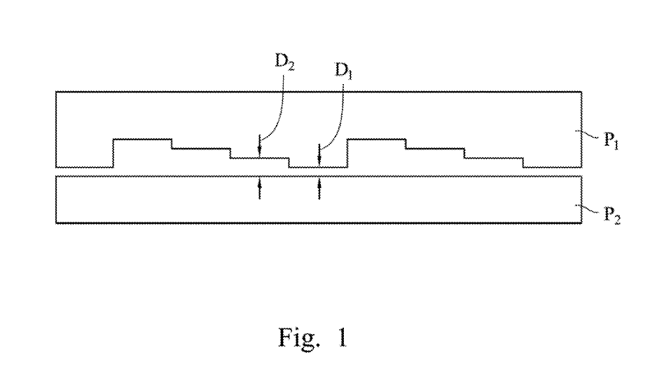

FIG. 1 is a schematic diagram of a mechanism in accordance with one embodiment of the present disclosure. In an environment of computer software, users need several entity patterns to design a physical structure. As illustratively shown in FIG. 1, there are a first entity pattern and a second entity pattern. In some embodiments, more entity patterns can be included in the environment of computer software, not shown in the figure.

The first entity pattern P1 and the second entity pattern P2 have different design shapes, and there is no interference between the two entity patterns P1 and P2. Clearances exist between the first entity pattern P1 and the second entity pattern P2, such as clearance D1 and D2 shown in FIG. 1.

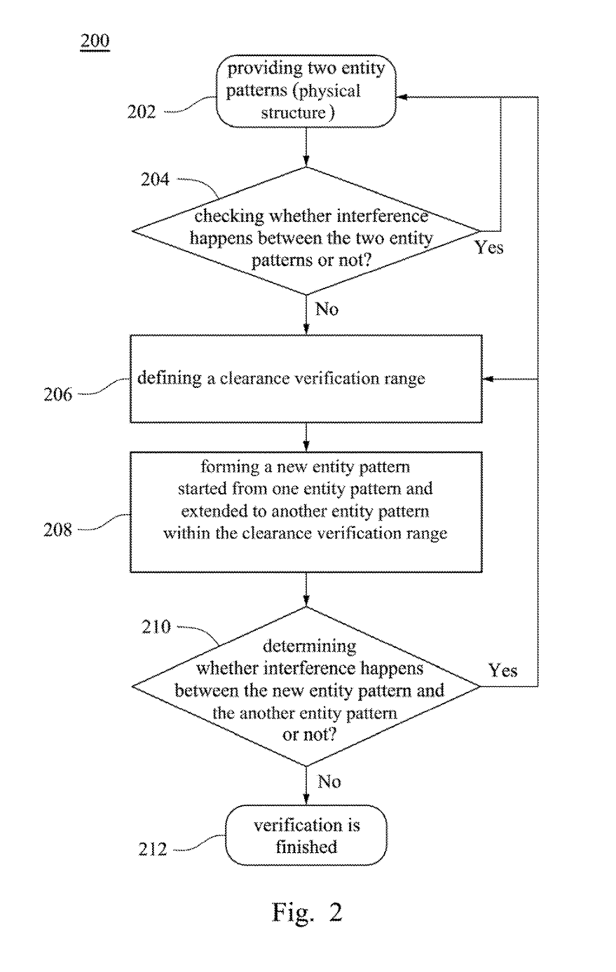

Reference is made to FIG. 2, which illustrates a flow chart of a verification method 200 in accordance with one embodiment of the present disclosure. In some embodiments, the verification method 200 is applied in Computer Aided Design (CAD) software. In step 202, a physical structure is designed by the users through an interface of computer-based software, and the physical structure can be constructed by combining several entity patterns. Different clearances are formed according to relative positions of the different entity patterns in the physical structure.

In step 204 is performed to check if interference happens between the two entity patterns P1, P2. In an embodiment as shown in FIG. 1, when there is no interference between the two entity patterns P1, P2, which means that two entity patterns P1, P2 do not overlap each other, clearances exist between the two entity patterns. In an embodiment, when interference exists between two entity patterns P1, P2, which means that two entity patterns P1 and P2 partially overlap each other (not shown in the figure), there will be not clearance existed between the overlapping portions of two entity patterns P1 and P2.

In step 204, when it is confirmed that there is interference between the two entity patterns P1, P2 and there is no clearance between the two entity patterns P1, P2, the verification method 200 returns to step 202 for redesign the layout of the physical structure and the verification method 200 will not move to further steps. If there is no interference between the two entity patterns P1, P2 and the two entity patterns P1, P2 do not overlap each other, clearances exist between the two entity patterns P1 and P2. Dimensions of the clearances will be verified in the following steps.

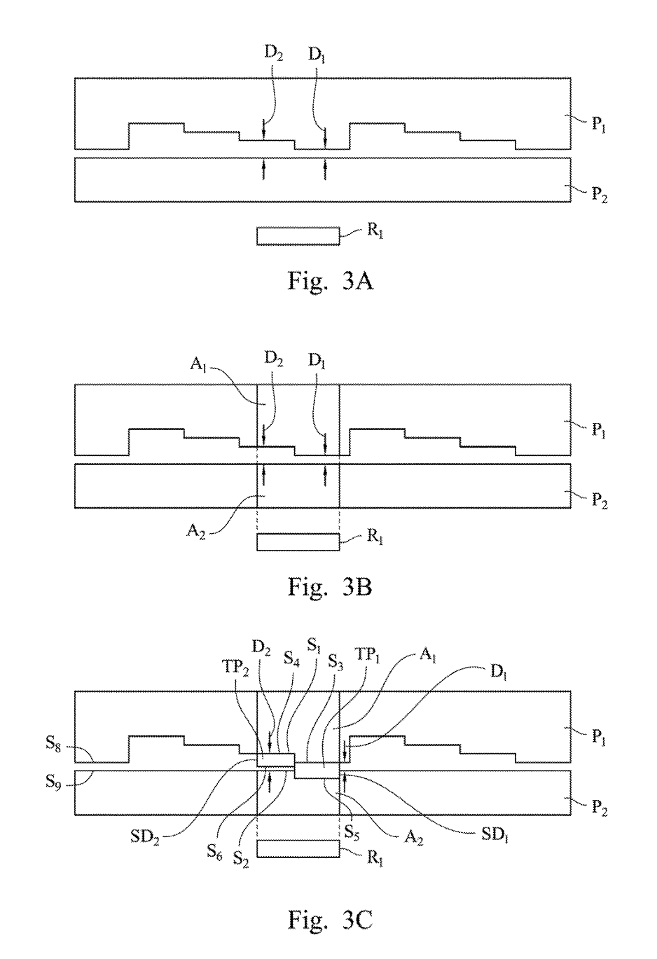

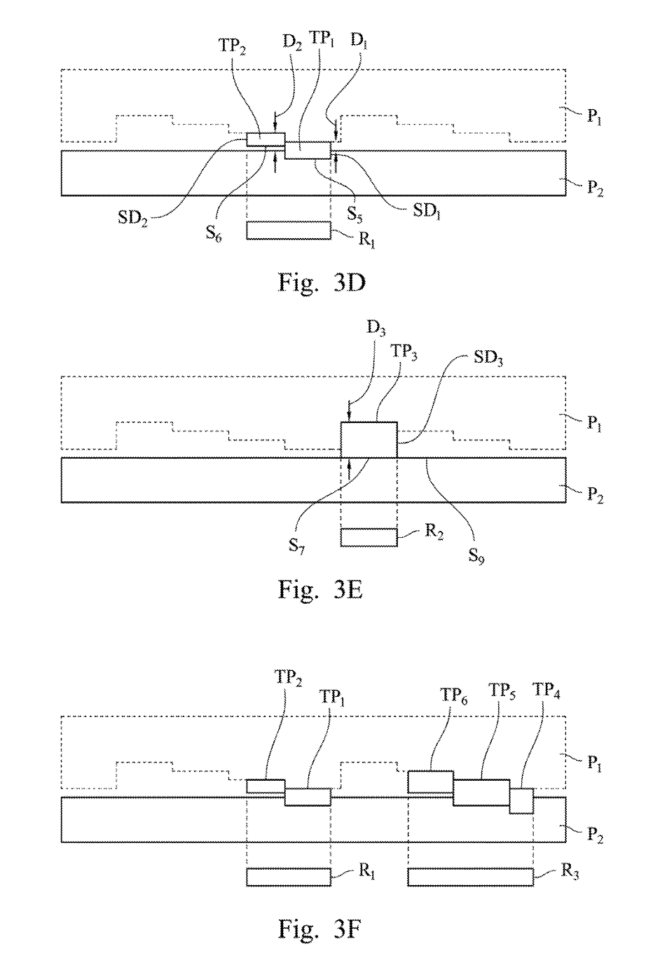

References are made to FIG. 3A to FIG. 3E, which are schematic diagrams illustrating entity patterns in clearance verification according to embodiments of the present disclosure. In step 206, a clearance verification range is defined by the users in a computer graphic interface. The purpose of defining the clearance verification range is to select a range for verification with a specific length. The range with the specific length can be smaller than or equal to a total length of an entity pattern, and the length range for verification can cover one or more clearances between two entity patterns.

As illustratively shown in FIG. 3A, the user defines a clearance verification range R1 for the first entity pattern. P1 and the second entity pattern P2. In the embodiment, the length of the clearance verification range R1 is part of the total length of the first entity pattern P1 and the second entity pattern P2, and the clearance verification range R1 covers the clearance D1 and D2. In practical, the length of the clearance verification range R1 can be defined as same as the length of the first entity pattern P1 and the second entity pattern P2. In other words, more clearances can be covered for verification when the length of the clearance verification range R1 is larger. Contrarily, fewer clearances between the first entity pattern P1 and the second entity pattern P2 can be covered for verification if the length of the clearance verification range R1 is smaller. The present disclosure is not limited to aforementioned embodiments.

After defining parts of designer's interest to be verified from the whole entity patterns, the clearance verification range R1 will correspond to a partial pattern of entity patterns. The length of the clearance verification range R1 is the same as the length of the partial pattern of designer's interest to be verified. As illustratively shown in FIG. 3B, the clearance verification range R1 corresponds to a first partial pattern A1 of the first entity pattern P1 and a second partial pattern A2 of the second entity pattern P2 when the clearance verification range R1 is defined by the user, and the first partial pattern A1 and the second partial pattern A2 have the same length as the clearance verification range R1.

The clearance verification range R1 corresponds to at least one clearance between the first partial pattern A1 of the first entity pattern P1 and the second partial pattern A2 of the second entity pattern P2. For example, the clearance verification range R1 corresponds to the clearance D1 and D2, as shown in FIG. 3. When the length of the clearance verification range R1 increases, more clearances between the first partial pattern A1 of the first entity pattern P1 and the second partial pattern A2 of the second entity pattern P2 will be covered. The scope of the present disclosure is not limited to the clearance D1 and D2, and more clearances can be covered in other embodiments.

In step S208, a new entity pattern is formed, and a side edge of the new entity pattern is started from a side edge of the first partial pattern A1, which the side edge of the first partial pattern A1 faces toward the second partial pattern A2. The side edge of the new entity pattern is adjacent to the side edge of the first partial pattern A1 facing to the second partial pattern A2, and the length of the side edge of the new entity pattern is the same as the length defined by the clearance verification range R1 The new entity pattern is formed by projecting the new entity pattern started from the first partial pattern A1 and extended toward the second partial pattern A2 according to a predetermined clearance value. The new entity pattern is extended along a vertical axis relative to side edges of two entity patterns P1, P2 toward the second entity pattern P2. When the vertical height of the new entity pattern reaches the predetermined clearance value, another side edge of the new entity pattern is decided, so that the new entity pattern is established according to the predetermined clearance value.

As illustratively shown in FIG. 3C, the clearance verification range R1 covers the clearance D1 and D2, and the predetermined clearance value SD1 and SD2 are decided in advance respectively corresponding to the clearance D1 and D2. The side edge S3 of the new entity pattern TP1 and the side edge S4 of the new entity pattern TP2 are located adjacent to the side edge S1 of the first partial pattern A1, and the new entity pattern TP1 and TP2 are established by projecting from the side edge S3/S4 and extending toward the second partial pattern A2 along the vertical axis relative to the side edges S8 of the first entity pattern P1 and the side edges S9 of the second entity pattern P2.

In the embodiment, the side edge S3 of the new entity pattern TP1 and the side edge S4 of the new entity pattern TP2 are adjacent to the side edge S1 of the first partial pattern A1 The side edge S5 is formed when a projected length of the new entity pattern TP1 reaches the predetermined clearance SD1, and then the new entity pattern. TP1 is established. The side edge S6 is formed when a projected length of the new entity pattern TP2 reaches the predetermined clearance SD2, and then the new entity pattern TP2 is established.

In aforementioned embodiment, a clearance verification range (e.g., R1 in FIG. 3A) has been defined in order to verify dimensions of the gap existed between the first and the second entity patterns P1 and P2. In another embodiment, the new entity pattern is formed in the gap without defining the clearance verification range (e.g., R1 in FIG. 3A) in advance. In other word, the new entity pattern is established corresponding to a full length of the first and the second entity patterns P1 and P2. A side edge of the new entity pattern is adjacent to a side edge of the first entity pattern P1, and the new entity pattern is started from the side edge of the first entity pattern P1 and projected toward a side edge of the second entity pattern P2 according to a predetermined clearance value of each clearance between the two entity patterns P1 and P2. Compared to the aforementioned embodiment, verification will be performed for all clearances between the two entity patterns concurrently in this embodiment, not only for clearances covered by the clearance verification range (e.g., R1 in FIG. 3A).

When the new entity pattern has been established, the step 210 is executed to perform interference inspection. The interference inspection is utilized to detect whether an interference occurs between the new entity pattern and the second entity pattern. The second entity pattern is opposite to the original entity pattern (the first entity pattern) where the new entity pattern is started from. In some embodiments, the interference inspection is a function provided in the CAD software to verify the clearance design. In other words, step 210 is performed by the function of interference inspection in the CAD software to determine whether or not the new entity pattern formed according to the predetermined clearance value is overlapped with the other entity pattern (the second entity pattern), and further to determine whether the clearance between the two entity patterns complies with a safe range of clearance design.

When the interference happens between the new entity pattern and the other entity pattern (e.g., the second entity pattern P2 in FIG. 1.), the new entity pattern formed by projecting according to the predetermined clearance value is located within the range of the other entity pattern, so that the new entity pattern partial overlaps with the second entity pattern. P2. In other words, the clearance between the two entity patterns (e.g., P1, P2 in FIG. 1) is smaller than the predetermined clearance value, and the dimension of clearance between the two entity patterns (e.g., P1, P2 in FIG. 1) is not within the safe range of the clearance design. In other words, the clearance between the two entity patterns is not wide enough to a standard of the clearance design. When interference does not happen between the other entity pattern (e.g., P2 in FIG. 1) and the new entity pattern, the new entity pattern formed by projecting according to the predetermined clearance value is not located within the range of the other entity pattern (e.g., P2 in FIG. 1), and the new entity pattern does not overlap with the second entity pattern P2. In this case, the clearance between the two entity patterns (e.g., P1, P2 in FIG. 1) is larger than or exactly equal to the predetermined clearance value, and it is determined that the dimension of clearance between the two entity patterns (e.g., P1, P2 in FIG. 1) complies with the safe range of the clearance design.

As illustratively shown in FIG. 3D, the side edge S5 of the new entity pattern TP1 is located within the range of the second entity pattern P2, and the new entity pattern TP1 partial overlaps with the second entity pattern P2. It is determined that the clearance D1 between the first entity pattern P1 and the second entity pattern P2 is smaller than the predetermined clearance design SD1. In other words, the dimension of clearance D1 between the first entity pattern P1 and the second entity pattern P2 is not within the safe range of the clearance design. In this case, the method 200 returns to step 206 to redefine the clearance verification range or return to step 202 to redesign the physical structure so that the size of clearance D1 between the first entity pattern P1 and the second entity pattern P2 complies with the safe range of the clearance design.

Also as illustratively shown in FIG. 3D, the side edge S6 of the new entity pattern TP2 is not located within the range of the second entity pattern P2, and the new entity pattern TP2 does not overlap with the second entity pattern P2. It is determined that the clearance D2 between the first entity pattern P1 and the second entity pattern P2 is larger than the predetermined clearance design SD2, and is further determined that the dimension of the clearance D2 between the first entity pattern P1 and the second entity pattern P2 complies with the safe range of clearance design, and then the verification for the clearance is finished in step 212.

In another embodiment, as illustratively shown in FIG. 3E, a clearance verification range R2 is defined in advance for verification, and the side edge S7 of the new entity pattern TP3 is exactly located beside the side edge S9 of the second entity pattern P2. It means that the side edge S7 of the new entity pattern TP3 is exactly adjacent to the side edge S9 of the second entity pattern P2, and the new entity pattern TP3 does not overlap with the second entity pattern P2. In this case, the clearance D3 is exactly equal to the corresponding predetermined clearance value SD3. It is determined that the size of clearance D3 between the first entity pattern P1 and the second entity pattern P2 complies with the safe range of clearance design, and the verification for the clearance is finished in step 212.

The technique described above can be applied to verify several clearances between two entity patterns concurrently. As illustratively shown in FIG. 3F, a clearance verification range R3 is defined to be longer than the clearance verification range R1. Comparing to the clearance verification range R1 the clearance verification range R3 can cover more clearances between the first entity pattern P1 and the second entity pattern P2 and establish more new entity pattern TP4, TP5 and TP6 to verify if the clearances comply with the safe range of clearance design or not. The verification method based on the new entity pattern TP4, TP5 and TP6 is the same as the verification method 200 described above and not repeated herein.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fail within the scope of the following claims.

What is claimed is:

1. A verification method, especially applied in a Computer Aided Design (CAD) software, the verification method comprising:
providing a first entity pattern and a second entity pattern, a clearance exists between the first entity pattern and the second entity pattern;
forming a third entity pattern according to a predetermined clearance value, the third entity pattern starts from an edge of the first entity pattern and extends toward the second entity pattern; and
using a function of interference inspection provided in the CAD software to verify the clearance design based on whether the third entity pattern partially overlaps the second entity pattern.

2. The verification method of claim 1, wherein the third entity pattern comprises a first side edge and a second side edge opposite to the first side edge, the first entity pattern comprises a third side edge facing to the second entity pattern, the second entity pattern comprises a fourth side edge facing to the first entity pattern, in step of forming the third entity pattern, the first side edge of the third entity pattern is closely adjacent to the third side edge of the first entity pattern, the third entity pattern is formed by projecting the third entity pattern started from the third side edge of the first entity pattern across the clearance and extended toward the fourth side edge of the second entity pattern, a projecting length of the third entity pattern is the predetermined clearance value.

3. The verification method of claim 2, wherein the third entity is formed by projecting the third entity pattern started from the third side edge of the first entity pattern across the clearance and extended toward the fourth side edge of the second entity pattern along a vertical axis relative to the third side edge of the first entity pattern and the fourth side edge of the second entity pattern.

4. The verification method of claim 2, wherein when the second side edge of the third entity pattern is projected within a range of the second entity pattern, the third entity pattern partially overlaps the second entity pattern.

5. The verification method of claim 2, wherein when the second side edge of the third entity pattern is projected out of a range of the second entity pattern, the third entity pattern does not overlap the second entity pattern.

6. The verification method of claim 1, wherein steps of forming the third entity pattern comprises:
defining a clearance verification range corresponding to a first partial pattern of the first entity pattern and a second partial pattern of the second entity pattern; and
forming the third entity pattern, the third entity pattern is started from an edge of the first partial pattern and extended toward the second partial pattern according to the predetermined clearance value, wherein a length of the third entity pattern is equal to a length of the clearance verification range.

7. The verification method of claim 1, wherein when the third entity pattern partially overlaps the second entity pattern, the clearance is not verified within the safe range of clearance design.

8. The verification method of claim 1, wherein when the third entity pattern does not overlap the second entity pattern and a gap exists between the third entity pattern and the second entity pattern, the clearance is verified within the safe range of clearance design.

9. The verification method of claim 1, wherein when the third entity pattern does not overlap the second entity pattern exactly and no gap exists between the third entity pattern and the second entity pattern, the clearance is verified within the safe range of clearance design.

10. The verification method of claim 1, wherein the predetermined clearance value is reserved as a gap design value between the first entity pattern and the second entity pattern while designing the first entity pattern and the second entity pattern.
